(19) United States
(12) Patent Application Publication
(10) Pub. No.: US 2025/0018658 A1
(43) Pub. Date: Jan. 16, 2025

(54) 3D Printed Grass Replicas and Method

(71) Applicant: Edward Tettey Nartey, District Heights, MD (US)

(72) Inventor: Edward Tettey Nartey, District Heights, MD (US)

(21) Appl. No.: 18/473,643

(22) Filed: Sep. 25, 2023

Related U.S. Application Data
(60) Provisional application No. 63/513,230, filed on Jul. 12, 2023.

(51) Int. Cl. B29C 64/393; B29C 64/40; B33Y 10/00; B33Y 50/02; B33Y 80/00; G06Q 30/0601

(52) U.S. Cl. CPC B29C 64/393; B29C 64/40; B33Y 10/00; B33Y 50/02; B33Y 80/00; G06Q 30/0621; G06Q 30/0643

(57) ABSTRACT

A 3D printed grass replica(s) for installation outdoors in place of natural grass. The replicas include 3D printed grass of desired density, size, and blade size on foundation slabs or sections. The slabs can be installed outdoors and provide aesthetics of a lawn, ground, and the like while requiring little maintenance. In some embodiments, a process of ordering 3D printed grass replicas is disclosed. The process begins by providing natural grass photographs by a user using a mobile application to a manufacturer, processing user-provided grass photographs into 3D models capturing natural variations in grass attributes. The process includes automated selection of 3D printing material and technology and printing grass on the foundation slabs or sections.

### CROSS-REFERENCE TO RELATED APPLICATION

The present application claims priority to, and the benefit of, U.S. Provisional Application No. 63/513,230, which was filed on Jul. 12, 2023 and is incorporated herein by reference in its entirety.

### FIELD OF THE INVENTION

The present invention relates generally to the field of 3D printing systems and artificial grass. More specifically, the present invention relates to a novel artificial grass slab that presents a 3D printed replica grass image. The 3D printed replica blends in with the appearance of existing grass blades. The sides of the slab have a parallel view of the grass, whereas the top would present a bird's eye view. A user can customize the appearance of the slab based on the appearance of their current grass using a submitted photo. Photographs can be submitted to a manufacturer, so the client's lawn matches their natural grass color and structure in an aesthetically pleasing manner. Accordingly, the present disclosure makes specific reference thereto. Nonetheless, it is to be appreciated that aspects of the present invention are also equally applicable to other like applications, devices, and methods of manufacture.

### BACKGROUND

By way of background, people like to maintain a lush, vibrant lawn and garden area surrounding their home. A bright and green lawn not only provides pleasure to homeowners but also significantly enhances the outdoor aesthetics of their property. However, growing and maintaining grass in lawns and garden is challenging and time consuming. For example, in areas with harsh weather conditions such extreme hot or extreme cold, maintaining a consistently green lawn and garden can be difficult. Extreme heat, cold, or water scarcity can prevent natural grass from thriving, resulting in a barren or patchy landscape that doesn't contribute to the desired outdoor aesthetic.

Further, traditional lawn maintenance requires a significant investment of time and effort. Regular mowing, watering, fertilizing, and weeding are necessary for growing and maintaining grass. Commonly, lawn mowers are used for lawn maintenance which can have negative environmental impacts as most lawn mowers are gasoline powered. The combination of necessary equipment, water usage, fertilizers, and more make maintaining a natural lawn expensive. Furthermore, the process of growing and nurturing grass is slow and may take months. It is often a common problem for homeowners to have uneven grass patches due to factors like shade, poor soil quality, or high foot traffic. This leads to unattractive landscapes. As a result, homeowners desire an alternative to natural grass that offers case of installation and minimal maintenance while providing aesthetics of natural grass.

Therefore, there exists a long felt need in the art for an alternative to natural grass for lawns and grounds. There is also a long felt need in the art for artificial grass that looks like natural grass and is easy to maintain. Additionally, there is a long felt need in the art of grass replica that can be easily manufactured and customized as per user requirements. Moreover, there is a long felt need in the art for 3D printed grass slabs that can replace natural grass and provide a desired look and aesthetics for lawns. Further, there is a long felt need in the art for a novel 3D printed grass replica that reduces pollution and carbon emissions by eliminating the need to use a lawn mower. Furthermore, there is a long felt need in the art of artificial grass slabs that are easy to install and maintain and can be used in all weathers. Finally, there is a long felt need in the art for 3D printed artificial grass slabs that function as a way to create an aesthetically pleasing lawn area for homes, road and highway areas, parks, and gardens, and numerous other residential or commercial areas.

The subject matter disclosed and claimed herein, in one embodiment thereof, comprises a method for manufacturing 3D printed grass replicas on foundation slabs or sections. The 3D printed grass replicas are used in place of natural grass in lawns and grounds. The method includes the steps of utilizing a 3D printing machine operated by a manufacturer, printing a green grass replica by employing the 3D printing machine to layer 3D printed green grass upon a foundation (i.e., concrete slab), wherein characteristics comprising density and shape of grass blades are preconfigured within the 3D printing machine and based on one or more photographs of grass received from a user. The grass replica provides diverse viewing angles, encompassing a lateral perspective from sides of the foundation and a top-down perspective that simulates a bird's eye view. The replicas can be arranged in any lawn, ground, or other outdoor areas for aesthetics of natural grass.

In this manner, the 3D printed grass replica slabs or sections of the present invention accomplish all of the forgoing objectives and provide users with 3D printed replica grass that can be arranged to form a desired look. The replicas can be based on user requirements and resemble natural grass. The foundations or slabs reduce pollution and carbon emissions and enable users to have the foundation slabs or sections of replica grass installed around their home's outdoor area.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer-implemented system for facilitating the ordering and receipt of 3D printed grass replicas. The 3D printed grass replicas are designed to be used in lawns and grounds to replace natural grass. The system comprising a handheld user device having a software application installed thereon, the software application configured to establish wireless communication with at least one 3D printed grass replica manufacturer, the software application further configured to provide a plurality of user interfaces for facilitating the customization and ordering of 3D printed green grass replicas, wherein the 3D printed grass replicas are printed on foundation slabs or sections by a manufacturer and are designed for even installation around outdoor areas, thereby emulating the appearance of natural grass in a uniform manner.

In yet another embodiment, a method for manufacturing 3D printed green grass replicas is described. The method includes the steps of utilizing a 3D printing machine operated by a manufacturer, printing a green grass replica by employing the 3D printing machine to layer 3D printed green grass upon a concrete slab or foundation section, wherein characteristics comprising density and shape of grass blades are preconfigured within the 3D printing machine. The grass replica provides diverse viewing angles, encompassing a lateral perspective from sides of the foundation and a top-down perspective that simulates a bird's eye view.

In yet another embodiment, a mobile application for facilitating ordering of customizable 3D printed grass replicas on foundation slabs or sections for installation in lawns and grounds is disclosed. The mobile application provides an interface for providing a “Take photo/Upload photo” tab enabling users to capture or upload photos using a camera of a user device, the photos being employed for generating 3D models intended for subsequent 3D printing. A “size specifications” tab for providing users the option to specify dimensions of foundation slabs or sections utilized for producing 3D grass replicas, with selectable preconfigured sizes and recommendations based on image processing. A “payment” tab for providing secure payment options via an integrated payment module.

In yet another embodiment, a method for generating 3D printed grass replicas is described. The method comprising the steps of receiving user-submitted grass photographs by a manufacturer, performing photograph processing, transforming the photographs into a 3D model, encompassing attributes encompassing grass height, color, texture, and blade orientation variations, automatically selecting 3D printing material and technology based on the 3D model, and 3D printing grass onto foundation slabs or sections.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the 3D printed green grass replica system of the present invention in accordance with the disclosed architecture;

FIG. 2 illustrates a perspective view of an exemplary 3D printing machine used for creating a 3D printing grass replica of the present invention in accordance with the disclosed architecture;

FIG. 3 illustrates an exemplary user interface displayed by the application for enabling a user to upload a photo of the grass desired by the user in accordance with the disclosed architecture;

FIG. 4 illustrates a flow chart depicting a process of creating 3D printed grass using the system of the present invention in accordance with the disclosed architecture;

FIG. 5 illustrates a perspective view of different sizes of the 3D printed grass replicas of the present invention in accordance with the disclosed structure; and

FIG. 6 illustrates a perspective view showing 3D printed grass replicas installed in a garden for landscaping in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an alternative to natural grass for lawns and grounds. There is also a long felt need in the art for artificial grass that looks like natural grass and is easy to maintain. Additionally, there is a long felt need in the art of grass replica that can be easily manufactured and customized as per user requirements. Moreover, there is a long felt need in the art for 3D printed grass slabs or grass sections that can replace natural grass and provide a desired look and aesthetics for lawns. Further, there is a long felt need in the art for a novel 3D printed grass replica that reduces pollution and carbon emissions by eliminating the need to use a lawn mower. Furthermore, there is a long felt need in the art of artificial grass slabs or sections that are easy to install and maintain and can be used in all weathers. Finally, there is a long felt need in the art for 3D printed artificial grass sections that function as a way to create an aesthetically pleasing lawn area for homes, along road and highway areas, parks and gardens, and numerous other residential or commercial areas.

The present invention, in one exemplary embodiment, is a computer-implemented system for facilitating the ordering and receipt of 3D printed grass replicas. The 3D printed grass replicas are designed to be used in lawns and grounds to replace natural grass. The system comprising a handheld user device having a software application installed thereon, the software application configured to establish wireless communication with at least one 3D printed grass replica manufacturer, the software application further configured to provide a plurality of user interfaces for facilitating the customization and ordering of 3D printed green grass replicas, wherein the 3D printed grass replicas are printed on foundation slabs or sections by a manufacturer and are designed for even installation around outdoor areas, thereby emulating the appearance of natural grass in a uniform manner.

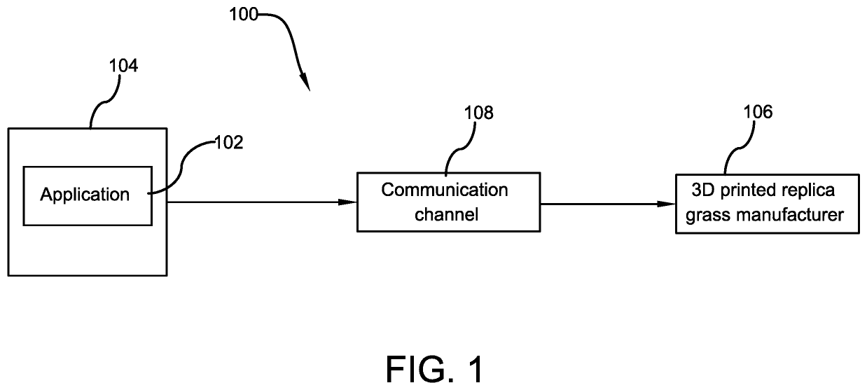

Referring initially to the drawings, FIG. 1 illustrates a schematic view of the 3D printed grass replica system of the present invention in accordance with the disclosed architecture. The 3D printed grass replica system 100 is designed to enable users such as homeowners to collaborate with 3D printing services and manufacturers to order and receive 3D printed replicas of green grass for their lawns and gardens. More specifically, the system 100 is a computer implemented system that includes a software application 102 installed in a handheld user device 104. The software application 102 is used by a user for contacting a 3D printing grass replica manufacturer 106 for ordering 3D printed grass replicas. The application 102 communicates using a wireless communication channel 108 such as Wi-Fi, cellular, or any other communication channel.

The application 102 is configured to provide a plurality of interfaces for enabling a user to order custom 3D printed green grass replicas. The system 100 can be provided by a manufacturer or alternatively can be provided a 3^{rd} party which can enroll a plurality of 3D printing manufacturers in the artificial grass ordering and receipt system 100. The application 102 uses input device such as camera, keypad, touchscreen, and more of the user device 104 for receiving an input from a user and provides the input to the manufacturer 106 for green grass replicas. In the present invention, the grass replica is 3D printed on foundation slabs or sections that can be installed easily and evenly around outdoor areas of a home, thus, providing the appearance of natural and uniform grass.

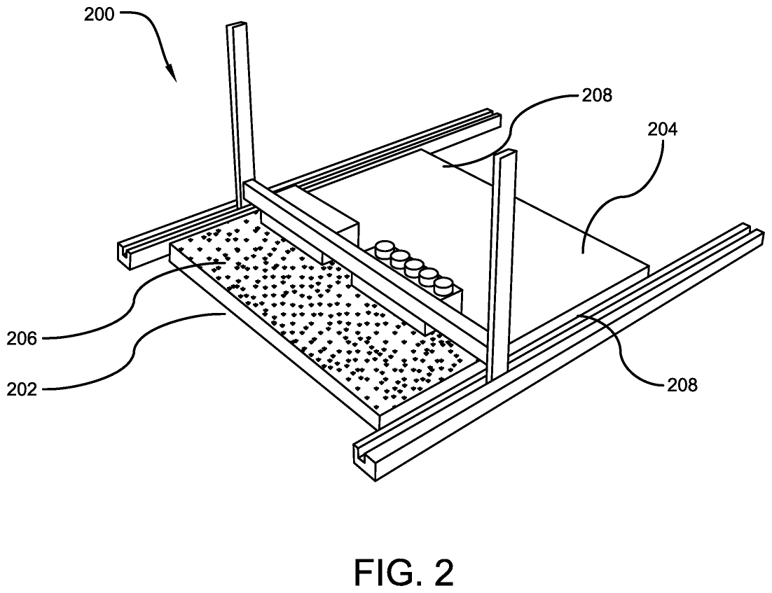

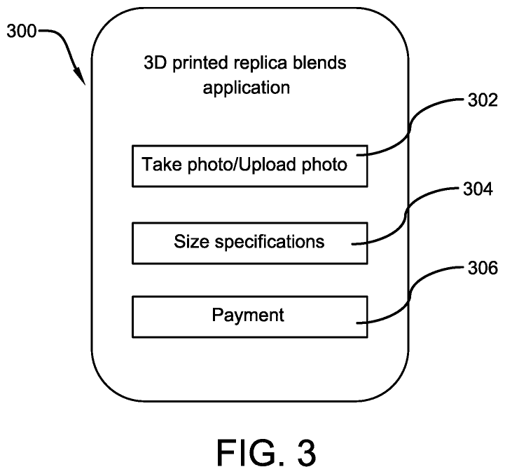

FIG. 2 illustrates a perspective view of an exemplary 3D printing machine used for creating a 3D printing grass replica of the present invention in accordance with the disclosed architecture. The manufacturer 106 uses the 3D printing machine 200 for printing green grass replica 202 by 3D printing green grass 206 on a foundation slab or section 204. The density and shape of the blade of grass is preconfigured in the machine 200 as described in FIG. 3 in detail.

Foundation slabs or sections 204 of different shapes can be used for making the 3D printed green grass replica 202 and further the machine 200 can be manually or automatically operated for an easy and quick operation of making green grass replicas 202. The grass replica 202 provides different viewing angles including a parallel view of the grass from sides 208 of the slab 204. From the top, a bird's eye view is provided for enhancing the overall realism of the replicated grass to blend with natural grass.

FIG. 3 illustrates an exemplary user interface displayed by the application 102 for enabling a user to upload a photo of the grass desired by the user in accordance with the disclosed architecture. An advantage of the present invention is that users can order 3D printed grass replicas of different sizes as per their requirements. Any grass shape, color and type can be ordered by users for manufacturers to manufacture. As illustrated, the user interface 300 provides a Take photo/Upload photo tab 302 which enables users to take one or more photos using camera of the user device 104 or directly upload the photos to be received by the manufacturer 106. The photos are used for creating a 3D model for 3D printing to match or emulate the uploaded photos. The photos can be in different formats including but not limited to .jpg, .png, .jpeg, and more.

A size specifications tab 304 is used for providing foundation slab size used for creating 3D grass replicas. Users can provide any custom size or predeterminable size or can also select from one or more preconfigured sizes in the application 102. In some embodiments of the present invention, the application 102 may recommend one or more slab sizes based on processing of the image.

A payment tab 306 is provided for enabling users to securely pay for the replica grass order. The application 102 has an integrated payment module that can accept different payment methods for enabling users to pay the manufacturer for making 3D printed grass replicas.

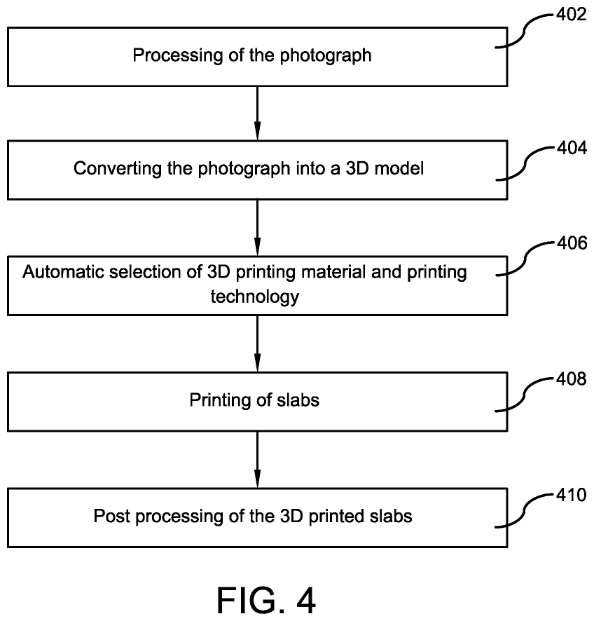

FIG. 4 illustrates a flow chart depicting a process of creating 3D printed grass using the system 100 of the present invention in accordance with the disclosed architecture. Initially, the manufacturer 106 receives one or more photographs of the grass desired by a user (sent by the user in FIG. 3) and processing of the photographs is performed (Step 402). Then, the photographs are converted into a 3D model to be used for creating 3D grass foundation slabs or sections as illustrated in FIG. 2 (Step 404) to emulate the grass in the photographs. The 3D model captures the natural variations in grass height, color, texture, and variations in blade orientation.

Based on the 3D model, in the next step 406, a 3D printing material and technology are automatically selected for creating 3D printed grass on foundation slabs or sections. It will be apparent to a person skilled in the art that technologies like stereolithography (SLA), digital light processing (DLP), or selective laser sintering (SLS) can be used for 3D printing. In some embodiments, the foundation slabs or sections can also be 3D printed. In the next step 408, the slabs are printed with grass as illustrated in FIG. 2 using the 3D printing machine. Full color 3D printing can be used for replicating grass to match or emulate the natural color and variation of the grass in the photograph submitted by the user. Also, the 3D printing process may involve building up a plurality of layers of material to create the grass replica. Finally, in step 410, post processing including removing support structures, smoothing surfaces, and applying protective coatings are performed and a notification is sent to the user about completion of the 3D printed grass replicas.

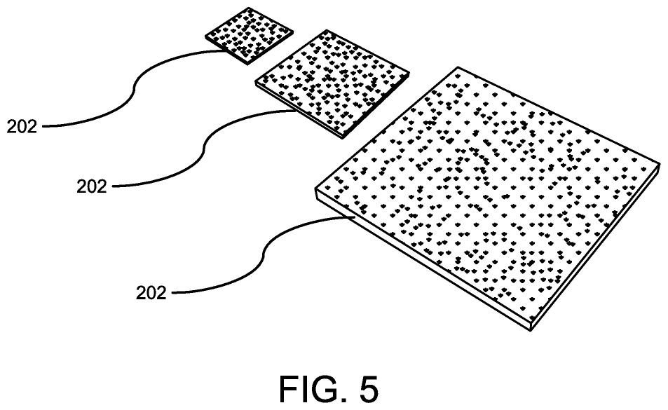

FIG. 5 illustrates a perspective view of different sizes of the 3D printed grass replicas of the present invention in accordance with the disclosed structure. As illustrated, the 3D printed grass replica 202 can be formed in different sizes and shapes as per requirements of users to install in their gardens and lawns.

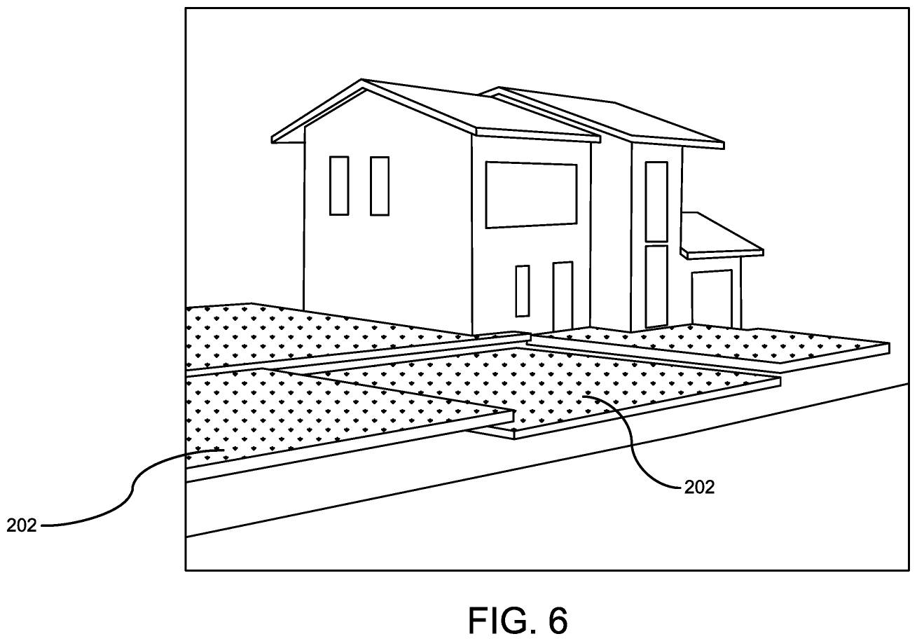

FIG. 6 illustrates a perspective view showing 3D printed grass replicas installed in a garden for landscaping in accordance with the disclosed structure. The grass replicas 202 can be installed on any type of surface such as a concrete surface and can be fixed permanently or temporarily using adhesives, glue, cement, or other types of fasteners. It should be noted that the grass replicas 202 are easy to maintain, have longevity, and maintain visual appeal of the outside area. Furthermore, the grass slabs 202 eliminate the need for gasoline-powered lawn mowers and reduce water usage. The use of replica grass slabs 202 provides a uniform and consistent appearance across the entire lawn.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “3D printed grass replica system”, “artificial grass ordering and receipt system”, and “system” are interchangeable and refer to the 3D printed grass replica system 100 of the present invention. Similarly, as used herein “green grass replica”, “3D printed grass replica”, and “replicas” are interchangeable and refer to the 3D printed green grass replica 202 of the present invention.

Notwithstanding the forgoing, the 3D printed grass replica system 100 and the 3D printed green grass replica 202 of the present invention can be of any suitable size and configuration as is known in the art without affecting the overall concept of the invention, provided that it accomplishes the above stated objectives. One of ordinary skill in the art will appreciate that the 3D printed grass replica system 100 and the 3D printed green grass replica 202 as shown in the FIGS. 1-2 and 5 are for illustrative purposes only, and that many other sizes and shapes of the 3D printed grass replica system 100 and the 3D printed green grass replica 202 are well within the scope of the present disclosure. Although the dimensions of the 3D printed grass replica system 100 and the 3D printed green grass replica 202 are important design parameters for user convenience, the 3D printed grass replica system 100 and the 3D printed green grass replica 202 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A 3D printing grass replica system comprising:
a handheld computer user device having a software application including a camera and a contact link for contacting a 3D printing grass replica manufacturer;
wherein said contacting said 3D manufacturer including ordering 3D printed grass replicas;
wherein said application having a wireless communication channel for communicating with said 3D printing grass replica manufacturer;
wherein said ordering 3D printed grass replicas including sending a photo of natural grass with said application to said 3D printing grass replica manufacturer;
wherein said 3D printing grass replica manufacturer emulates said photo of natural grass with a 3D printed section of grass;
wherein said emulating including matching said 3D printed section of grass with said photo of natural grass; and
further wherein said matching including a matching color.

2. The 3D printing grass replica system of claim 1, wherein said matching including a matching density.

3. The 3D printing grass replica system of claim 1, wherein said matching including a matching shape.

4. The 3D printing grass replica system of claim 1, wherein said matching including a matching type.

5. The 3D printing grass replica system of claim 1 further comprising a foundation section, wherein said 3D printed section of grass is printed onto said foundation section.

6. The 3D printing grass replica system of claim 5, wherein said foundation section is a predetermined size during said ordering 3D printed grass replicas.

7. A 3D printing grass replica system comprising:
a handheld computer user device having a software application including a camera and a contact link for contacting a 3D printing grass replica manufacturer;
wherein said contacting said 3D manufacturer including ordering 3D printed grass replicas;
wherein said application having a wireless communication channel for communicating with said 3D printing grass replica manufacturer;
wherein said ordering 3D printed grass replicas including sending a photo of natural grass with said application to said 3D printing grass replica manufacturer;
wherein said 3D printing grass replica manufacturer emulates said photo of natural grass with a 3D printed section of grass;
wherein said emulating including matching said 3D printed section of grass with said photo of natural grass; and
further wherein said matching including a matching color and a matching shape.

8. The 3D printing grass replica system of claim 7, wherein said matching including a matching density.

9. The 3D printing grass replica system of claim 7, wherein said matching including a matching type.

10. The 3D printing grass replica system of claim 7 further comprising a foundation section, wherein said 3D printed section of grass is printed onto said foundation section.

11. The 3D printing grass replica system of claim 10, wherein said foundation section is a predetermined size during said ordering 3D printed grass replicas.

12. A method of replicating natural grass with a 3D printing grass replica system, the method comprising the steps of:
providing a handheld computer user device having a software application including a camera and a contact link for contacting a 3D printing grass replica manufacturer, wherein said contacting said 3D manufacturer including ordering 3D printed grass replicas;
communicating with said 3D printing grass replica manufacturer with said application, wherein said application having a wireless communication channel;
sending a photo of natural grass with said application to said 3D printing grass replica manufacturer;
emulating said photo of natural grass with a 3D printed section of grass from said 3D printing grass replica manufacturer, wherein said emulating including matching said 3D printed section of grass with said photo of natural grass; and
matching at least a color of said photo of natural grass with a color of said 3D printed section of grass.

13. The method of replicating natural grass of claim 12 further comprising a step of matching a shape of said photo of natural grass with a shape of said 3D printed section of grass.

14. The method of replicating natural grass of claim 12 further comprising a step of matching a density of said photo of natural grass with a density of said 3D printed section of grass.

15. The method of replicating natural grass of claim 12 further comprising a step of matching a type of said photo of natural grass with a type of said 3D printed section of grass.

16. The method of replicating natural grass of claim 12 further comprising a step of matching a height of said photo of natural grass with a height of said 3D printed section of grass.

17. The method of replicating natural grass of claim 12 further comprising a step of matching a texture of said photo of natural grass with a texture of said 3D printed section of grass.

18. The method of replicating natural grass of claim 12 further comprising a step of providing a foundation section, and a step of printing said 3D printed section of grass onto said foundation section.

19. The method of replicating natural grass of claim 18, wherein said foundation section is a predetermined size during said ordering 3D printed grass replicas.

20. The method of replicating natural grass of claim 12 further comprising the steps of:
removing support structures from said 3D printed section of grass;
smoothing surfaces of said 3D printed section of grass; and
applying protective coatings to said 3d printed section of grass.
